(19) United States
(12) Patent Application Publication
(10) Pub. No.: US 2007/0271714 A1
(43) Pub. Date: Nov. 29, 2007

(54) LIGHT-BASED ENHANCING APPARATUSES AND METHODS OF USE

(75) Inventors: Horst R. Adam, San Mateo, CA (US); Victor C. Esch, Albuquerque, NM (US); Marc P. Maisel, Los Altos, CA (US); Joseph Robert Rimsa, Palo Alto, CA (US)

Correspondence Address: PAUL, HASTINGS, JANOFSKY & WALKER LLP, P.O. BOX 919092, SAN DIEGO, CA, 92191-9092, US

(73) Assignee: Light Dimensions, Inc.

(21) Appl. No.: 11/686,797

(22) Filed: Mar. 15, 2007

Related U.S. Application Data
(60) Provisional application No. 60/783,290, filed on Mar. 17, 2006.
(60) Provisional application No. 60/783,303, filed on Mar. 17, 2006.
(60) Provisional application No. 60/783,808, filed on Mar. 17, 2006.
(60) Provisional application No. 60/822,904, filed on Aug. 18, 2006.
(60) Provisional application No. 60/822,912, filed on Aug. 18, 2006.
(60) Provisional application No. 60/822,915, filed on Aug. 18, 2006.

(51) Int. Cl. A46B 13/02; A46B 15/00; A61C 17/00; B26B 21/00

(52) U.S. Cl. 15/22.2; 15/106; 30/32; 433/216

(57) ABSTRACT

Embodiments of light-based enhancing apparatuses and methods of use are described. In one embodiment, the light based-enhancing apparatus may comprise a toothbrush that includes a light source, a head with a plurality of bristles (and/or other materials that may be used to brush a tooth such as, e.g., a sponge, plastic prongs or resilient massaging rods/tips) and a window so that light emitted from the light source can pass through the window. In another embodiment, the light-based enhancing apparatus may comprise a razor or an electric razor that has a head with at least one blade and a light source that is adapted for emitting light proximal to the head of the razor.

### CROSS REFERENCES TO RELATED APPLICATIONS

This application claims benefit to U.S. Provisional Application Ser. No. 60/783,290, filed Mar. 17, 2006, to U.S. Provisional Application Ser. No. 60/783,303, filed Mar. 17, 2006, to U.S. Provisional Application Ser. No. 60/783,808, filed Mar. 17, 2006, to U.S. Provisional Application Ser. No. 60/822,904, filed Aug. 14, 2006, to U.S. Provisional Application Ser. No. 60/822,912, filed Aug. 14, 2006, and to U.S. Provisional Application Ser. No. 60/822,915, filed Aug. 14, 2006, each of which is hereby incorporated by reference herein in their entirety.

### TECHNICAL FIELD

Embodiments described herein relate generally to skin, tooth and gum treatment devices and more particularly to devices that use light, radiation and/or heat to provide a treatment to skin, hair, teeth and gums of a user.

### BACKGROUND

It has become increasingly common for people to use a variety of techniques to enhance the whiteness of their teeth. The desire for whitening procedures is particularly acute for people whose teeth have been stained through smoking or other tobacco products, chromomeric foods, endodontic treatment, tetracycline use, or discoloring due to aging. As a result, a multitude of products and services have been developed for whitening teeth.

The approaches for whitening teeth are varied. For example, there are direct photonic approaches that use lasers, bleaching through bleaching agents, sometime using light to enhance the bleaching process. Typical bleaching agents include peroxides (e.g., hydrogen peroxide or carbamide peroxide) that are often used with added activators such as catalysts or accelerators, and other chemistries to vary pH. In a bleaching process, the effectiveness of the active agent such as hydrogen peroxide can be enhanced by increasing the temperature around the agent (and teeth). The effectiveness of the active agent may also be enhanced by a catalyst.

Over time the approaches for whitening have shifted from primarily dentist or doctor based procedures (or “office based procedures”), where the cost of procedures could be quite high, to over the counter products for in-home use, these being much less expensive but typically providing less effectiveness for the user. With an extended program of home bleaching, the exposure of the teeth to bleaching compounds can be significant in cumulative duration. This can typically be dramatically more than the time spent during an office-based bleaching procedure. As a result, the concentrations of bleaching compound utilized in an in-home whitening solution may be reduced in order to achieve a given whitening result. Likewise, with regard to temperature, the increase in temperature can be small for an enhanced effect, especially as compared to office based procedures for heat enhanced bleaching. Exposure to the enhanced bleaching concentration, due to the slightly elevated temperature, will be experienced for months. Indeed the exposure may be systematically applied for years or as long as an individual continues a regime of brushing teeth.

It is also known that exposing skin and other living tissue to light (i.e., electromagnetic radiation) can have therapeutic and healing value. By exposing skin to various wavelengths of light for a period of time, the skin and associated tissues can experience beneficial effects. Various treatments can be performed using light to reduce the effects of acne, for scar reduction, tissue rejuvenation, to evening out skin tones and skin roughness, for wrinkle reduction, for retarding hair growth (or for killing hair), for enhancing hair growth, and for bleaching hair. It may be advantageous to incorporate some or all of these beneficial effects in devices that are commonly and systematically used such as, for example, a razor or a shaver. These effects may thus be delivered during shaving to the skin on the face, legs, as well as other areas that might be shaved.

### SUMMARY

Embodiments of a light-based enhancing apparatuses and methods of use are described.

In one embodiment, the light based-enhancing apparatus may comprise a toothbrush that includes a light source, a head with a plurality of bristles (and/or other materials such as a sponge, plastic extents, etc.) and a window so that light emitted from the light source can pass through the window.

In one embodiment, the light source may be disposed in a handle of the toothbrush. In such an embodiment, a light tube may extends between the light source and the head, the light tube having at least one distal end located proximal to the window so that light emitted from the light source passes through the light tube to the distal end of the light tube. In another embodiment, the light source may emit light in the blue spectrum. For example, in one such embodiment, the light emitted from the light source can have a wavelength between about 400 nm and 500 nm.

The toothbrush may also include a heating element in the head. The heating element may be coupled to a power supply (such as a battery power supply) that provides energy to the heating element. In another embodiment, the heating element may be positioned so that it is close enough to the light source so that heat radiated by the light source is conducted to the heating element and then radiated by the heating element to the external area or regions proximal to the head of the toothbrush. As an option in the heating element embodiments, a temperature sensor may also be provided for controlling the heat radiated by the heating element.

In one embodiment, the bristles or other materials may be arranged in a ring around the window. In another embodiment, the toothbrush may include a motor for moving the bristles. For example, in one such embodiment, the bristles or other materials may be mounted to a (bristles assembly) that is, in turn, rotatably mounted to the head. The motor may be coupled to the (bristles) assembly in such a manner so that the (bristles) assembly can be moved (e.g., oscillated or rotated) by the movement of the motor (and thereby move the bristles as well).

In one embodiment, the toothbrush can be constructed from a housing having inner and outer portions with the outer portion comprising a material that either translucent or transparent. In such an embodiment, the inner housing may be constructed from a substantially opaque. In another embodiment, a cap may be provided with the toothbrush for covering the head and the bristles. In some such embodiments, the cap may have a reflective interior surface so that light from the light source can be reflected off of the interior of the cap and on to the bristles or other materials of the toothbrush. In a further embodiment, a catalytic material may be provided on at least the head of the toothbrush. In addition (or alternatively), the catalytic material can be provided on the (bristles) assembly (e.g., as a coating for instance). In one embodiment, the catalytic material may be provided on a removable cap that is detachably attached to the head.

In use, the toothbrush may be used for brushing teeth. When such a toothbrush is provided, the light source may be activated to emit light therefrom so that as the teeth are brushed with the bristles or other materials of the toothbrush, light from the light source shines on the teeth and/or in the mouth. In use, a catalyst may be applied to the bristles or other materials. In embodiments where the toothbrush has a heating element, the heating element may be activated during brushing in order to heat the mouth and more particularly, the area around the teeth being brushed by the bristles or other materials of the toothbrush.

In one embodiment, the light based-enhancing apparatus may comprise a razor or an electric razor having a head with at least one blade and a light source that is adapted for emitting light proximal to the head of the razor. In one such embodiment, the razor may include a light pipe extending between the light source and the head so that light emitted from the light source passes through the light pipe in order to emit light proximal to the head. In another embodiment, the light pipe may comprise a light that extends along at least a portion of the head of the razor/electric razor in order to shine light on to the area of skin being shaved and/or the area of skin that has just been shaved.

### BRIEF DESCRIPTION OF THE DRAWINGS

FIG. 1 is a schematic perspective view of a light-based enhancement toothbrush apparatus in accordance with one embodiment;

FIG. 2 is a schematic perspective view of the embodiment of the light-based enhancement toothbrush apparatus shown in FIG. 1 as seen from the head end;

FIG. 3 is a schematic perspective view of the embodiment of the light-based enhancement toothbrush apparatus shown in FIG. 1 as seen from the handle end;

FIG. 4 is a schematic top view of the embodiment of the light-based enhancement toothbrush apparatus shown in FIG. 1;

FIG. 5 is a schematic back view of the embodiment of the light-based enhancement toothbrush apparatus shown in FIG. 1;

FIG. 6 is a schematic side view of the embodiment of the light-based enhancement toothbrush apparatus shown in FIG. 1;

FIG. 7 is a schematic front view of the embodiment of the light-based enhancement toothbrush apparatus shown in FIG. 1;

FIG. 8 is a cross sectional view of a light-based enhancement toothbrush apparatus showing an exemplary interior;

FIG. 9 is a longitudinal cross-sectional view of a light-based enhancement toothbrush apparatus showing an exemplary interior;

FIG. 10 is a schematic block diagram of an illustrative circuit for an embodiment of a light-based enhancement toothbrush apparatus;

FIG. 11 is an exemplary electrical circuit diagram of an embodiment of a light-based enhancement toothbrush apparatus;

FIG. 12 is a schematic side view of an implementation of a head end of a light-based enhancement toothbrush apparatus in accordance with one embodiment;

FIG. 13 is a schematic back view of the implementation of a head end of a light-based enhancement toothbrush apparatus shown in FIG. 12;

FIG. 14 is a schematic front view of an implementation of a head end of a light-based enhancement toothbrush apparatus in accordance with an embodiment;

FIG. 15 is a cross-sectional view of a cover for a light source of a light-based enhancement toothbrush apparatus in accordance with an embodiment;

FIG. 16 is a cross-sectional view of an exemplary cap that may be used to cover the head of a light-based enhancement toothbrush apparatus in accordance with one embodiment;

FIG. 17 is a cross-sectional side view of a light enhancement razor apparatus in accordance with one embodiment;

FIG. 18 is a cross-sectional side view of a head region of a light enhancement razor apparatus in accordance with one embodiment;

FIG. 19 is a cross-sectional side view of another implementation of a head region for a light enhancement razor apparatus with the light pipe free ends situated to project light through the spaces between the blades and towards the skin and hair follicles of a user during use;

FIG. 20 is a partial cross-sectional side view of the implementation of the head region shown in FIG. 19 in use;

FIG. 21 is a cross-sectional side view of a further implementation of a head region of a light enhancement razor apparatus in accordance with one embodiment;

FIG. 22 is a partial cross-sectional side view of the implementation of the head region shown in FIG. 21 showing exemplary light paths for light emitted from the treatment LED(s);

FIG. 23 is a cross sectional side view of a head region of a light enhancement razor apparatus having a light manifold in accordance with one embodiment;

FIG. 24 is a cross sectional side view of a head region of a light enhancement razor apparatus having a light manifold in accordance with one embodiment;

FIG. 25 is a plan view light manifold implemented light enhancement razor apparatus in use;

FIG. 26 is a cross sectional view of an exemplary light manifold in accordance with one embodiment;

FIG. 27 is a front view of an exemplary light manifold implemented light enhancement razor apparatus;

FIG. 28 is a cross sectional side view of an exemplary light manifold in accordance with one embodiment;

FIG. 29 is a cross sectional side view of an exemplary light manifold containing a in accordance with one embodiment;

FIG. 30 is a cross sectional view of a basic configuration of a light manifold in accordance with one embodiment;

FIG. 31 is a cross sectional side view of a light manifold with convex inner surfaces in accordance with one embodiment;

FIG. 32 is a cross sectional view of a light manifold with convex inner surfaces in accordance with one embodiment;

FIG. 33 is a cross sectional side view of a light manifold with exemplary lenslets in accordance with one embodiment;

FIG. 34 is a cross sectional view of a light manifold with exemplary lenslets in accordance with one embodiment;

FIG. 35 is a front view of a triple rotating blade head type electric razor with a centrally locating emitting region in accordance with one embodiment;

FIG. 36 is a front view of another embodiment of a triple rotating blade head type electric razor;

FIG. 37 is a front view of an embodiment of a triple rotating blade head type electric razor with a light manifold extending around the outer periphery of the head of the razor;

FIG. 38 is a front view of an embodiment of a triple rotating blade head type electric razor with a light manifold extending along one side of the outer periphery of the head of the razor;

FIG. 39 is a side view of a reciprocating blade type electric razor with a light manifold in accordance with one embodiment;

FIG. 40 is a front view of the reciprocating blade type electric razor with a light manifold shown in FIG. 39;

FIG. 41 is a side view of an implementation of the head of an exemplary embodiment of a light-based enhancement toothbrush apparatus having one or more catalytic surfaces;

FIG. 42 is a front view of an implementation of the head of an exemplary embodiment of a light-based enhancement toothbrush apparatus having a catalytic surface that extends around a treatment light source window that is position outside of the bristles; and

FIG. 43 is a front view of another implementation of the head of an exemplary embodiment of a light-based enhancement toothbrush apparatus having a catalytic surface positioned below a treatment light source window that is position outside of the bristles.

### DETAILED DESCRIPTION

Embodiments of light-based enhancing apparatuses and methods of use are described.

### Toothbrush Implementations

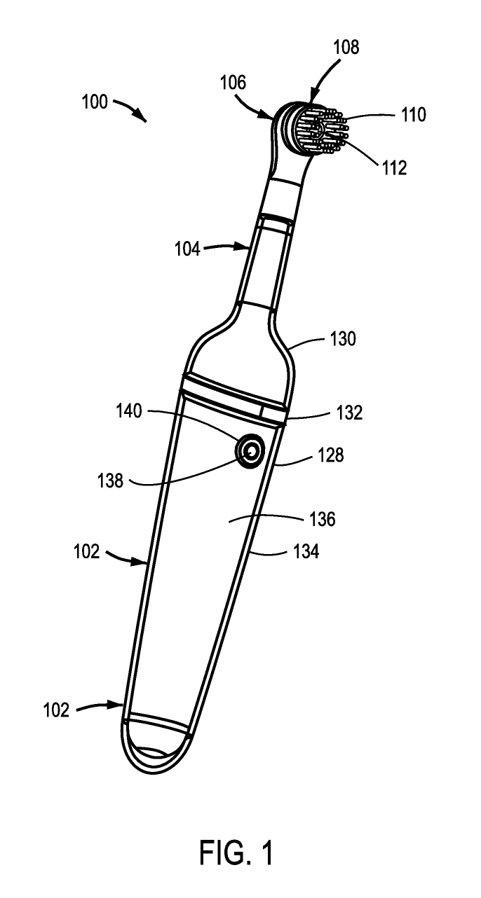

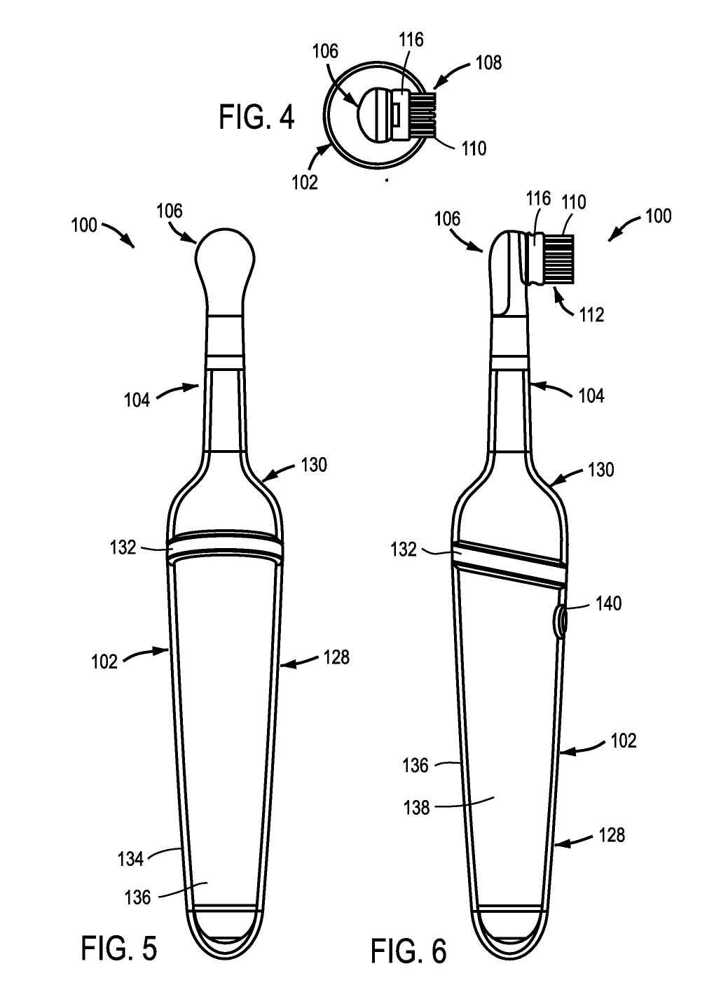

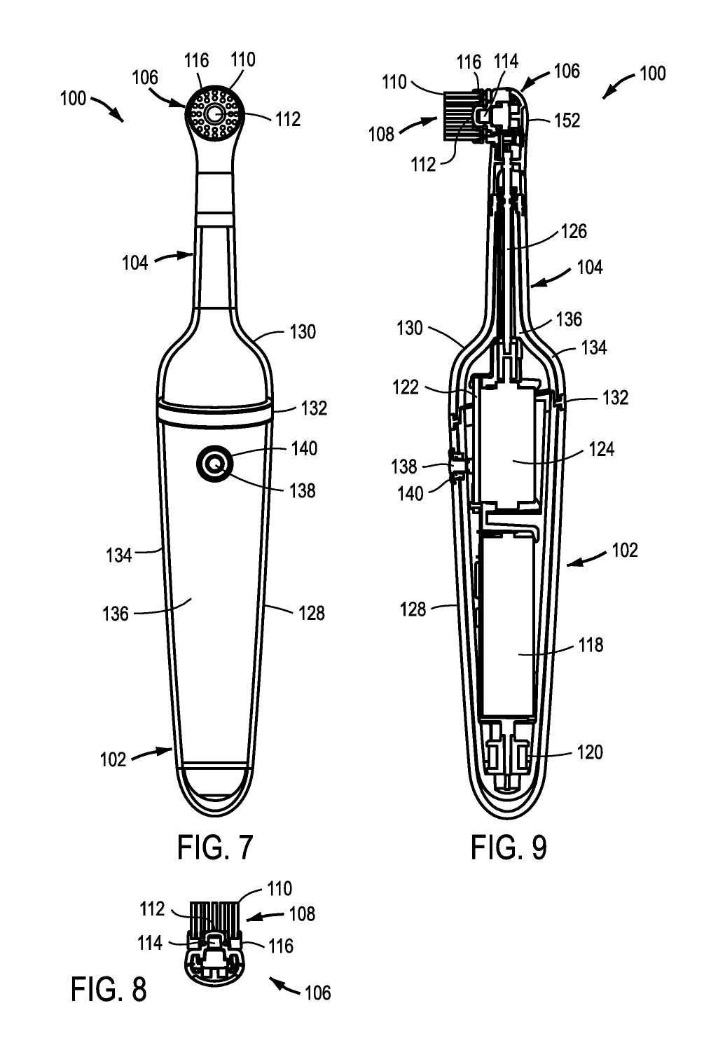

FIGS. 1-9 show an embodiment of a light-based enhancement toothbrush apparatus 100 (or “toothbrush”). As shown in FIGS. 1-9, the toothbrush 100 generally comprises a handle 102, a stem 104 (also referred to as a shaft) extending from the handle, and a head 106 (also referred to as a tip) at the other end of the stem. The head includes a bristles assembly 108 that includes a plurality of bristles 110 or other materials that are adapted for brushing teeth (and other dental surfaces).

In the embodiment depicted in FIGS. 1-9, the bristles 110 (it should be understood that other materials that can be used for brushing teeth may be used instead of or in addition to traditional toothbrush bristles such as, e.g., sponge(s), plastic extents, etc.)) may be arranged in a ring or annular arrangement around a treatment light window 112 (also referred to as a “light emitter” or “light emitting region”) through which light shines outwards from one or more treatment light sources 114 located inside the toothbrush 100. Placement of the treatment light source(s) 114 in such a location may be helpful in illuminating the area adjacent the teeth being brushed with the bristles. In one embodiment, the treatment light source(s) 114 may comprise one or more light emitting diodes (LEDs).

In some implementations of the toothbrush 100, light sources that emit a blue light may be utilized. For example, blue LEDs may be used as the treatment light source(s) 114. Exposure to blue light may be helpful in whitening teeth particularly, for example, blue light having, for example, a wavelength between 400 nm to 500 nm (although a blue light having a wavelength below 400 nm may also be utilized). It has been found that blue light alone and that bleaching compounds alone can whiten teeth. Using both blue light and bleaching compounds together in combination may help to provide an even greater effectiveness (than the use of either separately). The color of light may also be selected to help provide additional desirable actions such as, for example, treat gingivitis, enhance/enable tissue healing, re-mineralization of teeth, treat bad breath, diminish or eliminate dental caries and associated bacteria. Blue light, for example may also be used to diminish or eliminate microbes.

Increasing the intensity of the light from the treatment light source(s) 114 may enhance the net whitening effect provided by the emitted light. This is, generally speaking, a process mediated by exposure, in J/cm². For a given normal brushing time, it may, therefore, be advantageous to maximize the amount of power delivered from the light source(s).

A limiting issue in many cases can be the maximum permissible exposure for skin (MPEₛₖᵢₙ) to light from the treatment light source(s) 114. Presently, the MPEₛₖᵢₙ for intra-oral tissue is the same regulatory level as that for external skin namely, MPE<0.2 W/cm². Regardless of this limit, it is still desirable to deliver a maximal dose of light to the teeth without exceeding some limit that may be hazardous or that exceeds an accepted limiting exposure. Because, there is to be a brushing motion when using the toothbrush, exposure of the teeth to light from the treatment light source(s) 114 may be considered to a time average accumulation of light intensity upon a given location on the teeth.

Because LEDs are now available that can provide power levels that easily exceed the MPEₛₖᵢₙ levels, embodiments of the toothbrush 100 may integrate the LEDs as treatment light source(s) 114 in a variety of ways as described herein, that provide maximum dosages without exceeding an exposure limit, for example the accepted MPEₛₖᵢₙ.

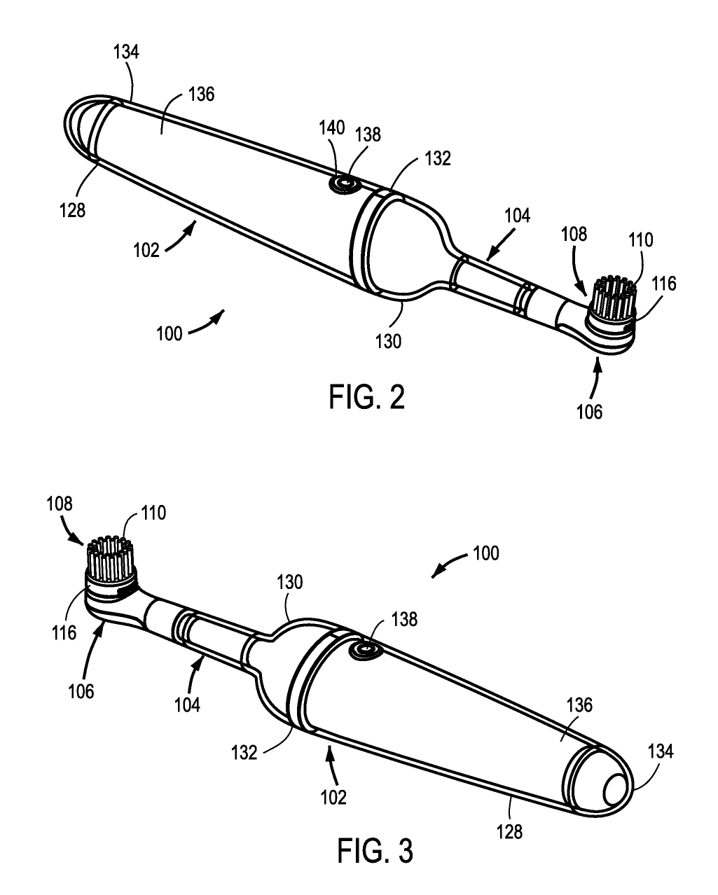

As best shown in FIGS. 2, 3, 4 and 6, the (bristles) assembly 108 may include a ring shaped seat 116 from which the bristles 110 extend. The treatment light window 112 may be positioned inside the center hole of the seat 116. In some embodiments, the seat 116 may be rotatably mounted to the head 106 of the toothbrush 100 to permit rotation (or at lease partial rotation or oscillation) of the seat 116 and thereby the bristles 110 (or other materials adapted for brushing teeth). Alternatively, the stem 104 may be designed so that it can be oscillated or vibrated (e.g., via mechanical, electromechanical or electronic means) to thereby effect a brushing motion with the bristles 110 during use of the toothbrush 100.

There are a number of ways of affording movement of the bristles 110 and/or bristles assembly 108. As shown in illustrative embodiment depicted in FIG. 9, the interior of the handle 102 may define a compartment that contains a battery power supply 118, an inductive recharging unit 120 for recharging the battery, and a printed circuit board (PCB) 122 having a microprocessor unit for controlling the operation of the various components of the toothbrush 100. A motor 124 may also be provided in the handle 102 that is coupled to (or engaged to) a drive shaft 126 that extends through the stem 104 to the head 106 of the toothbrush 100 where it engages gears or similar mechanisms for rotating, oscillating, moving and/or vibrating the bristles 110 and/or the bristles assembly 108. In this fashion, when the motor 124 is activated, the drive shaft 126 is moved and/or rotated to thereby, in turn, rotate, oscillate, move and/or vibrate the bristles 110 and/or the bristles assembly 108. Exemplary structures and methods for moving the bristles 110 and/or the bristles assembly 108 may also be found in U.S. Pat. Nos. 6,178,579, 6,189,693, 5,625,916 and 5,864,911 each of which is hereby incorporated by reference herein.

In one embodiment, the bristles assembly 108 may be detachable from the head 106 to permit convenient replacement or interchanging of the bristles assembly 108, for example, when the bristles 110 become worn out. In other embodiments, the stem 104 may be detachable from the handle 102 to permit convenient replacement or interchanging of the stem 104 and head 106 (with or without the bristles assembly 108).

In the embodiment shown in FIG. 1-9, the handle 102 and at least a portion of the stem 104 may be formed from a two part housing with the majority of the handle comprising a lower housing 128 and an upper portion of the handle and at least a portion of the stem forming an upper housing 130. The upper and lower housings 128, 130 may be coupled together, for example, by complementary threading. A trim ring 132 may also be provided at the union of the two housings 128, 130. Further details of the housings may be understood with reference to U.S. patent application Ser. No. 11/549,524 filed on Oct. 13, 2006 and entitled “Light-Based Dermal Enhancing Apparatus and Methods of Use” and which is hereby incorporated by reference in its entirety.

The housings 128, 130 may also be constructed so that they each have a transparent (or at least translucent) outer shell 134 and an opaque inner shell 136. The inner shells 136 may be shaped so that each can be nested in its respective outer shell 134. When the housings are assembled together, the inner shells may define an interior space of the housing. In a preferred embodiment, the inner and outer shells may be constructed from plastic materials with the inner shells 136 being made of a generally opaque plastic material and the outer shells 134 being made from a transparent or translucent plastic material.

When the housings are assembled together, the inner shells are located inside their respective outer shell with the open ends of the upper and lower housings 130, 128 coupled together. The trim ring 132 may be located in a joint region where these two portions meet. The upper and lower housings 130, 128 can be coupled together in a manner that prevents liquids from passing into the housing where the two portions meet (e.g., using a glue or adhesive or by fusing the portions together).

The handle 102 may include a control actuator 138 for activating the treatment light source(s) 114 and/or starting the motor 124 to cause the motion (e.g., rotation or oscillation or vibration) of the bristles. The handle 102 may also include a treatment indicator 140 that can provide a visual indication of the configuration or state in which the toothbrush 100 is in or configuration/state the toothbrush 100 is about to be in. As depicted in illustrative embodiment, the treatment indicator 140 can be ring-shaped (i.e., annular) and extend around an actuating portion of the control actuator 138 (i.e., the portion that a user touches or presses in order to actuate the actuator). As shown, in one embodiment, the control actuator 138 and treatment indicator 140 may be located in the lower housing 128. The inner and outer shells of the lower housing 128 may each have a side opening in which at least the actuating portion of the control actuator 138 can be located when the toothbrush 100 is assembled. As an option, a one-way seal may be provided between the actuating portion of the control actuator 138 and the peripheries of these side holes in order to provide a selective passage through the housing through which air and moisture can escape from the interior of the housing. Such as seal can be designed to be sufficiently robust in order to prevent water and other moisture from getting into the interior of the housing from the exterior (e.g., from a splash or accidental dunking of the toothbrush).

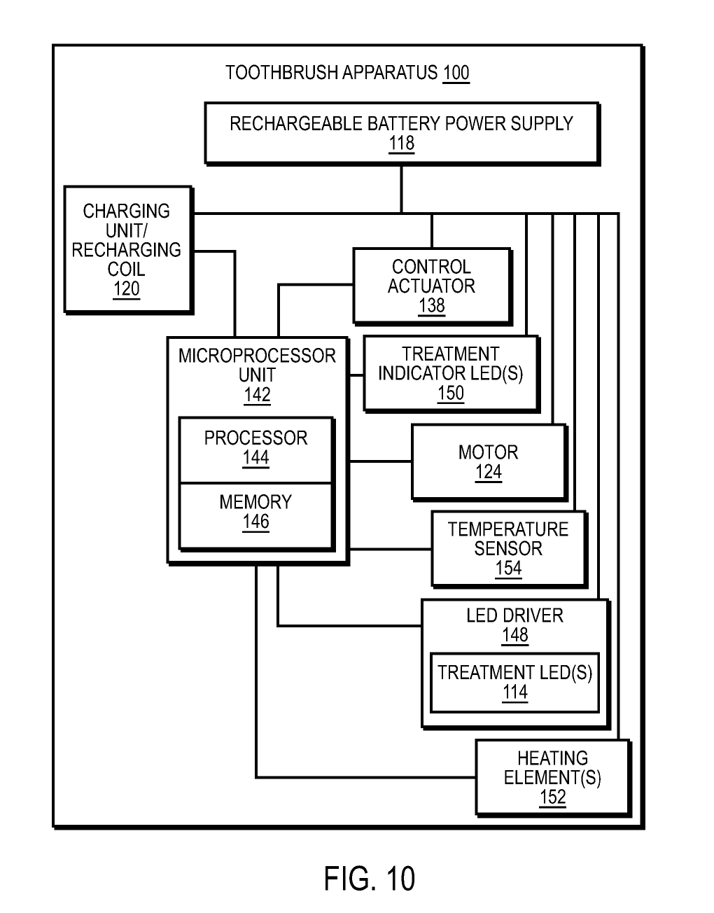

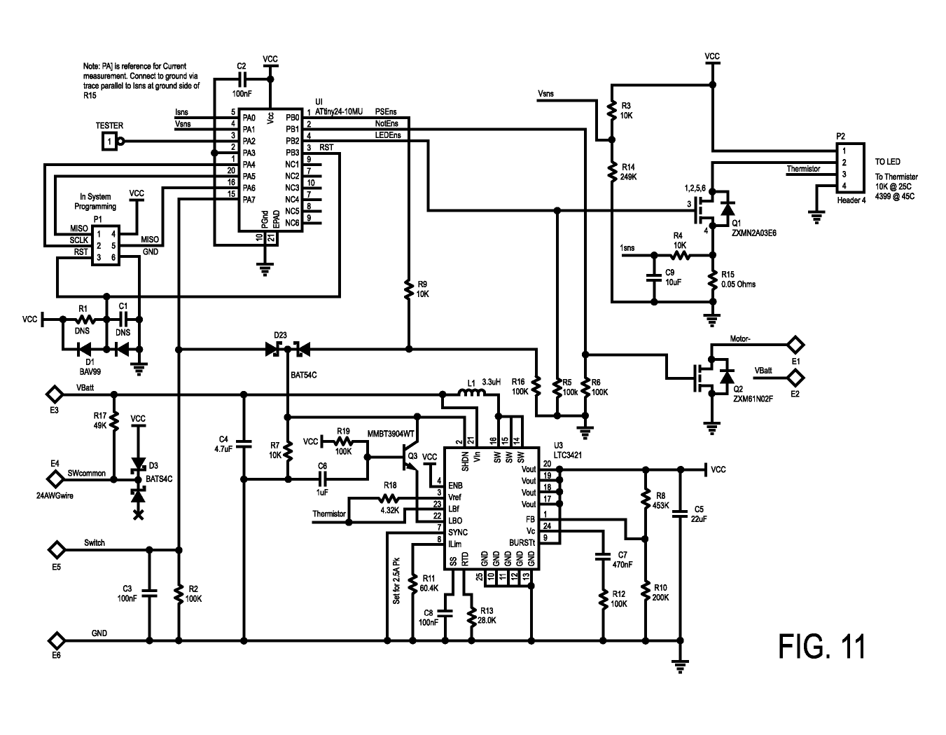

FIG. 10 depicts the various functional components of an illustrative light-based enhancement toothbrush apparatus 100 (an exemplary circuit diagram for at least some of these components of the toothbrush 100 is shown in FIG. 11). A rechargeable battery power supply 118 provides power to the various components shown in FIG. 10 while a microprocessor unit 142 (also referred to as “controller circuit”) controls operation of the various components and features of the toothbrush 100.

The microprocessor unit 142 may include a processor 144 and memory 146. Some or all of the microprocessor unit's 142 functionality for controlling the various components and features of the toothbrush 100 may be programmed into the processor 144 using software that can be stored, for example, in the memory 146. In one embodiment, the memory 146 can comprise a non-volatile flash-type memory. An inductive charging unit 120 may be provided for recharging the battery power supply 118 and may include a recharging coil for inductive recharging of the battery from an external power source. Control actuator 138 permits manual control of the microprocessor unit 142 and thereby can be used to control operation of the other components via the microprocessor unit 142. One or more treatment light sources 114 (e.g., LEDs) may be operated via a light source driver 148 (“LED driver”) under the control of the microprocessor unit 142. When activated, the light source driver 148 can cause the illumination of one or more of treatment light sources 114 included in the toothbrush 100.

One or more treatment indicator light sources 150 (“treatment indicator LEDs’) may also be provided to provide light for the treatment indicator 140. The motor 124 may be coupled to the drive mechanism (e.g., drive shaft 126) for moving/oscillating/vibrates the bristles and/or bristles assembly and/or head when the motor is activated. The microprocessor unit 142 may be coupled to the motor 124 and the treatment indicator light sources 150 in order to control them.

Embodiments of the toothbrush may be implemented to include some sort of heating element 152 in the head 106 of the toothbrush 100 in order to help heat a working fluid or compound or slurry (such as, e.g., a tooth whitening agent or a cleaning agent) and thereby help enhance the chemical process associated with the whitening or cleaning agent. Heating element(s) 152 provided in the head 106 may be shaped or positioned to conform to the shape of the head 106. As shown in the illustrative embodiment depicted in FIG. 8, the heating element 152 may be located along the back side of the head 106 of the toothbrush 100.

As depicted in FIG. 10, the heating element 152 may be coupled to the power supply 118 in the toothbrush 100 so that when the heating element 152 is activated (e.g., via a control actuator 138 and/or controller circuit 142), energy provided by the power supply may heat the heating element 152 (e.g., the heating element has a resistive heat load) so that heat conducts from the heating element 152 and heats the area proximal or adjacent to the head 106 of the toothbrush 100. Alternatively, the heating element 152 may be coupled to or placed adjacent to one of the internal treatment light sources 114 in the head 106 of the toothbrush 100 so that heat and/or light radiated from the light source 114 heats the heating element 152 and thereby causes the heating element 152 to radiate heat. In such an embodiment, the heat radiated by heating element may be controlled by controlling the level or intensity of light emitted by the treat light source 114.

In embodiments containing heating element(s) 152, the head 106 may also include a temperature sensor 154 to help detect the temperature around the head 106. The temperature sensor 154 may be coupled to the microprocessor unit 142 that controls the activation (i.e., turn on or off) of the heating element 152 and/or the treatment light source(s) 114 so that the heat generated by the heating element 152 may be controlled to maintain within a defined range such as, for example, an operating temperature range. In one implementation, the temperature sensor 154 may even comprise a temperature sensitive member such as, for example, a bimetallic structure or a nitinol structure that would provide a conduction path below a certain desired temperature and disconnect that path at a higher temperature.

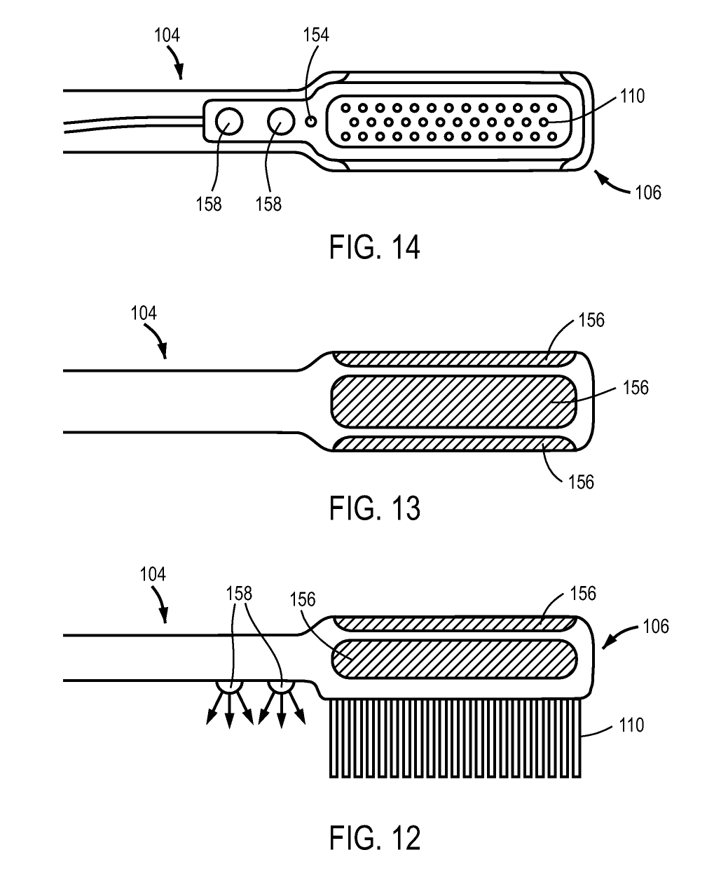

FIGS. 12, 13, 14 depicted another implementation of the head 106 of the toothbrush 100 with a traditional array of bristles 110. As shown in FIGS. 12, 13, 14, in such an implementation, the head may include one or more spreader regions 156 or sinks for helping to facilitate transfer of heat between the heating element(s) 152 and the area around the head 106 including any working fluid in the mouth. As shown, spreader regions 156 may be positioned on the back side of the head 106 opposite the bristles 110 and/or on the sides of the head 106. These spreader regions 156 may comprise some sort of thin barrier, such as a thin polymer layer, between the heating element(s) 152 and the area outside the head 106 of the toothbrush 100 in order to electrochemically isolate the heat sink material from direct contact to the working fluid.

Alternatively, the spreader regions 156 may be substituted with similarly located/shaped windows for permitting light to shine out of the head 106 from one or more treatment light sources 114 located in the head 106. These windows may also be frosted or translucent to help assist the diffusion of the emitted light. For example, the inside surface of a window(s) may be roughened or impregnated with a scattering material to provide a lambertian-like scattering transmission.

In use, the heating element 152 may be used to generate heat so that this heat may then be transmitted into the working fluid through some sort of conduction. The light power applied by the light source(s) 114 for enhanced whitening may also result in heating in a user's mouth. The heating by the heating element 152 and/or the light source 114 of 50 mW-300 mW may be useful in creating a useful temperature rise. In some cases higher deposited powers may be advantageous, for example 1W to about 3 W of deposited heating power.

As the action of any chemical reaction may commonly be enhanced by increasing temperature at which the reaction is experienced, a catalyst or accelerator may be employed to enhance the bleaching agents by, for example, incorporating a catalytic material as a heat spreading material. In this case, the catalytic reaction would take place at a higher temperature, via the active heat generation as described. The catalytic reaction could, for example, take place coincident with the location of deposition of energy for heating the working fluid. The working fluid would nominally contain the bleaching agent, and any other chemistry for enhancing the desired reaction, for example a material for optimally managing the pH at which the reaction takes place.

In another embodiment, a catalytic element can be provided on the head 106 of the toothbrush 100, such as, for example, a piece of metallic material (e.g., silver or platinum) or any other material that may act as a catalyst or accelerator in order to enhance the activity of the active agent in the bleaching process. In one embodiment, this catalytic element may be removably attached to (i.e., detachable from) the head 106 of the toothbrush (e.g., in any convenient location that enables interaction with the working fluid while brushing teeth). Such a detachable embodiment may be desirable if the catalytic agent is consumed or erodes during use, or whose effectiveness is otherwise compromised (such as, for example, by being covered, clogged, or sealed by residue).

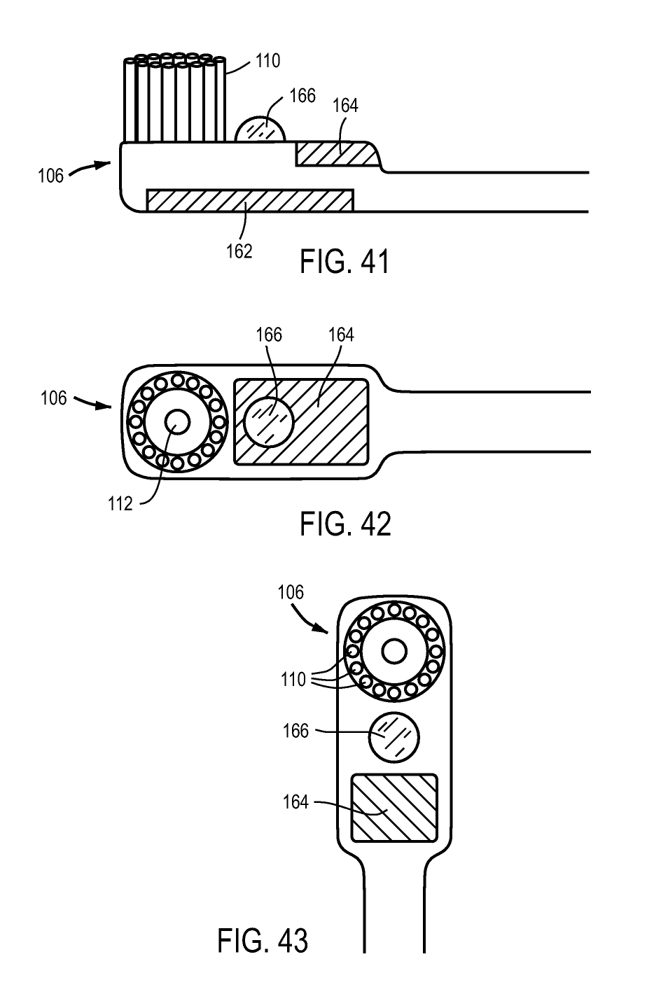

FIG. 41 is a side view of an implementation of the head 106 of an exemplary embodiment of a toothbrush 100 having one or more catalytic surfaces 162, 164. For example, a catalytic surface 162 may be provided on the back of the head 106. As another option (or in addition to), the catalytic surface 164 may be provided on the front of the head below the bristles. FIG. 42 is a front view of one implementation of the head 106 of an exemplary embodiment of a toothbrush 100 where the catalytic surface 164 extends around a treatment light source window 166 that is position outside of/below the bristles 110. FIG. 43 is a front view of another implementation of the head 106 of an exemplary toothbrush 100 where the catalytic surface 164 positioned is below a treatment light source window 166 that is position outside of/below the bristles 110. In each of these embodiments, the catalytic surface(s) 162, 164 may be provided on an insert that can be inserted (preferably removably) into a corresponding cavity or recess in the head 106 of the toothbrush 100. These catalytic inserts 162, 164 may have tangs, prongs, detents or other features that permit “snap on” attachment to the head 106 when inserted into the corresponding recess.

In another embodiment the catalytic surface may be provided on an attachment that may be mounted to the back of the head of the toothbrush by, for example, slipping the attachment over the top of the head so that side flanges (or similar structures) provided on the attachment may engage the sides of the head of the tooth brush. These side flanges may be resilient to help afford a biasing force such that the side flanges pinch the sides of the head and help hold the attachment to the head of the toothbrush. In such an embodiment, the catalytic agent may be provided on the exterior of the attachment (e.g., a catalytic material attached to or coating the exterior of the attachment).

Alternatively (or in addition to), the head 106 and/or the bristles assembly 108 of the toothbrush 100 can be coated with a catalytic material (such as, e.g., platinum or silver) to provide a similar effect. In such an embodiment, head 106 and/or bristles assembly 108 may be removable in order to afford more convenient replacement of the catalytic agent or with a head and/or bristles assembly that does not include the catalytic agent for those instances when a user does not wish to use the catalytic agent when brushing his or her teeth with the toothbrush 100.

The coating of the attachment, head 106 and/or bristles assembly 108 with a catalytic agent can be accomplished, for example, by evaporation, vapor deposition, plating processes, spraying or painting on to the head/bristles assembly, or any other material coating method.

In any of the catalytic surface/material implementations, the catalytic surface/material may include holes to increase the surface area of exposed catalytic material to further enhance the effect of the catalyst as the working fluid in a user's mouth (e.g., bleaching agent, saliva, toothpaste) comes into the catalytic surface/material.

As an option, one or more chamber(s) or delivery system(s) may be incorporated into the toothbrush to allow the delivery of one or more activating agents that optimize the performance of the bleaching process (e.g., a material containing a catalytic and or a material containing a chemistry to optimize the pH of the bleaching reaction). For example, a chamber may be provided in the head 106 of the toothbrush 100 that a user may fill up with an activating agent. Such a chamber may include an opening that permits output or outflow of the activating agent from the chamber/head of the toothbrush during use.

As best show in FIGS. 12 and 14, one or more additional or alternative light sources 158 (i.e., in addition to or alternatively to the one or more treatment light sources 114 inside the head 106) may be provided adjacent to the bristles 110 or other materials such as, for example, below the bristles 110 or other materials. Placement of light sources 158 in such a location on the head 106 may be useful in affording illumination to teeth towards the front of a user's mouth (i.e., those teeth that are visible when smiling).

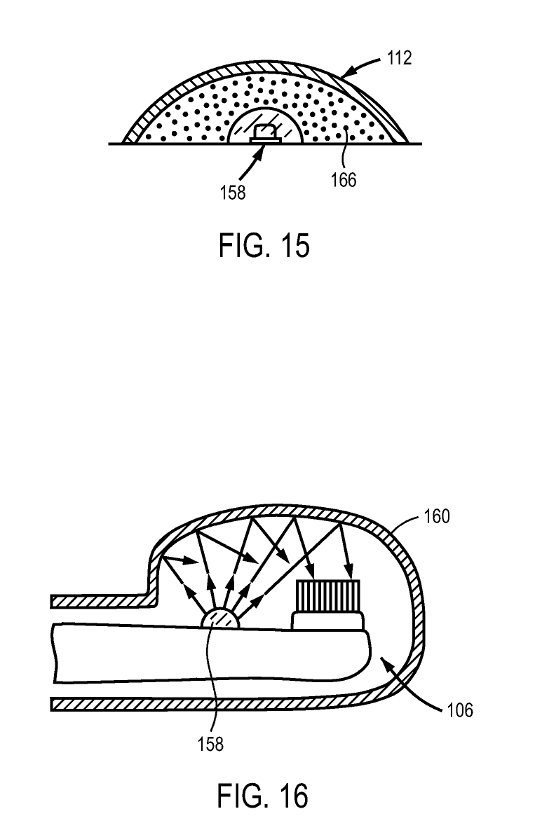

While depicted in FIG. 12 as being exposed, these light sources 158 may be covered with transparent or translucent covers (i.e., windows) to afford additional protection to them as shown in FIG. 15. In one implementation, the covers may be made from a plastic material. Such covers may also be frosted to aid diffusion of light from the light sources. For example, the inside surface of the cover may be roughened or impregnated with a scattering material to provide a lambertian-like scattering transmission. In addition or alternatively, the area inside the covers may contain a scattering media 166 such as, for example, a transparent material, for example a clear plastic or silicone, with an added scattering material such as SiO₂, to help afford an even light distribution at surface of the cover. The cover (and any added media therein) may also help to protect against delivering a power output that exceeds the MPEₛₖᵢₙ value from the light source. The cover (which may be hollow or solid) provides a spacing from the light source so that the maximum intensity accessible at the cover surface is just below MPEₛₖᵢₙ. If the intensity can be homogenized so that it is substantially uniform on the surface of the cover, then the maximal total power that may be applied during a given application duration may be approximated to the average brushing time using the toothbrush.

In some embodiments, a cap 160 for covering the head 106 of the toothbrush 100 may be provided as shown in FIG. 16. The interior surface of the cap 106 may be reflective to capture light emitted from the light sources of the head and reflect it back on the head to help eliminate bacteria, virus and/or fungi on the head. In one implementation, the cap 106 may include a light source (e.g., a blue light and/or UV light source) for illuminating the head without any requirements imposed by exposure of the light to human tissue. The cap 106 may be incorporated into a charging base or couplable to the power supply of the toothbrush so that the light source of the cap is powered by this power supply.

In use, the various embodiments and implementations of the toothbrush 100 may be used directly to whiten the teeth through the use of direct light exposure (in particular blue light exposure) on the teeth from the light source(s). The toothbrush 100 also may be used with whitening compounds such as, for example, bleaching agents or whitening toothpastes generally available to consumers. The toothbrush 100 may also be used with specialized toothpastes with chemistries or concentrations of bleaching agents that provide more effectiveness in whitening teeth. Embodiments of toothbrush 100 may also incorporate catalytic elements, or heated catalytic elements, as previously mentioned. Embodiments of the toothbrush 100 may also be used in conjunction with separate catalytic material(s) or chemistries in order to enhance the active agents (such as, e.g., materials to optimally manage the pH of the active chemical reaction).

An advantage of using the various toothbrush 100 embodiments described herein, as user's teeth are constantly kept in a working fluid (e.g., a toothpaste mixture with water and saliva, or a bleaching toothpaste and water and saliva) and, as a result, the user's teeth stay hydrated. Also, the presence of foaming material within the mouth may help to spread out the light such that more teeth are simultaneously exposed to the light. In contrast, in office-based teeth whitening systems, the teeth of a person receiving the treatment (who may also be referred to as the “patient”) are exposed to the ambient air and dehydrated because the light sources in these systems are typically located externally from the patient's mouth. This type of dehydration may detract from the effectiveness of the whitening treatment.

With some of the embodiments described herein, it may not be necessary to provide a high intensity spot because of the nature of the systematic motion used when brushing teeth. When using a small beam while making a brushing motion with the toothbrush, the intensity may be high but the exposure duration will be low. For example a transverse brushing motion of ten strokes upon a tooth region may expose a point on a tooth the 100 mW/cm² for 10× times a small period of time while for a large beam, the intensity may be 25 mW/cm² with the exposure time being much longer in duration.

It should be appreciated that there may be several therapeutic effects that can be provided by a light and/or heat enhancing toothbrush such as, for example, treatment of bad breath (including gingivitis), reduction of bacteria, reduction of cavities, healing gums, enhancing health of gums, and enhancing the properties of tooth enamel and calcification. Each of these phenomena may even be further optimized with a particular wavelength or series of wavelengths or progression of wavelengths of light from the light sources of the toothbrush. Implementations of the toothbrush may thus be optimized for use in the application for each or all of these applications, either alone, simultaneously, or in any combination.

In addition, embodiments of the toothbrush 100 may be implemented for separate adult and child implementations.

For example, in an adult implementation, the toothbrush 100 may have attributes consistent with providing therapeutic treatments. The adult toothbrush 100 may also have different operating modes including a mechanical massaging (i.e., vibrating or oscillating) feature. In addition, an adult implementation may have different colored light sources such as red, green and blue light emitting light sources to help improve gum health, re-mineralize weak enamel, kill bacteria, and whiten teeth.

On the other hand, in a child implementation, the toothbrush 100 may be designed to be disposable. In such an embodiment, the light sources may be utilized to provide an additional entertainment value for enhancing a child's tooth brushing experience. In addition, the control actuator implemented in a child's implementation of the toothbrush may, for example, comprise a capacitive switch that “comes alive” through the touch of the user's hand.

In use, the embodiments of the toothbrush 100 described herein may be used for brushing teeth. When such a toothbrush 100 is provided, the treatment light source(s) 114 may be activated to emit light therefrom so that as the teeth are brushed with the bristles of the toothbrush, light from the light source shines on the teeth and/or in the mouth. If a catalyst is to be applied, it may be applied to the bristles. In embodiments where the toothbrush has a heating element, the heating element may be activated during brushing in order to heat the mouth and more particularly, the area around the teeth being brushed by the bristles of the toothbrush.

### Razor Implementations

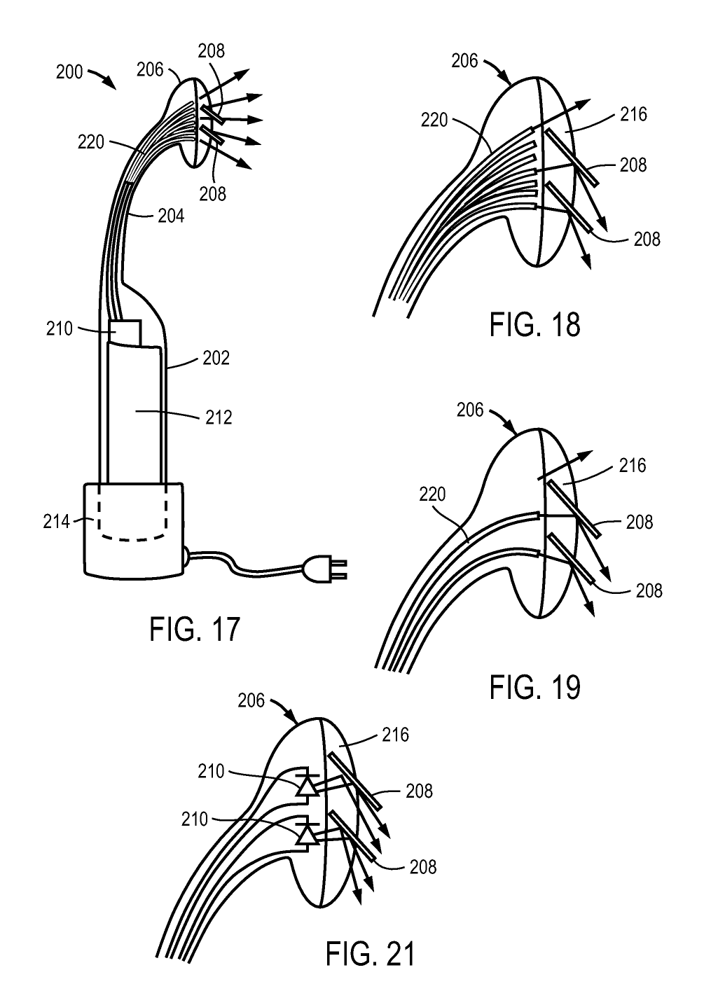

FIGS. 17-34 show various embodiments of a light enhancing razor apparatus.

With reference to FIG. 17, a light enhancing razor apparatus 200 (or “razor”) comprises a handle 202, a shaft 204, and a head 206 with the shaft 204 extending between the handle 202 and the head 206. The head 206 may include one or more shaving blades 208 that may be used to cut hairs when shaving a dermal surface (i.e., a skin surface) with the razor 200. While many of the embodiments described herein contain two blades, it should be understood that embodiments may be implemented with one blade or several blades.

The razor 200 may include one or more treatment light sources 210 so that light may be emitted from or proximal the head 206 of the razor so that light may be shined on the skin while shaving with the razor. In one preferred embodiment, the light sources 210 may comprise one or more light emitting diodes (LEDs). In another embodiment, the light sources 210 may comprise laser diodes. The color of the light emitted by the light sources 210 may depend on the implementation. For example, a blue light emitting light source may be included in the razor 100 to assist in bleaching hair and/or skin and serve as an anti-bacterial agent. A pulsed red light or near infrared (NIR) emitting light source may be included for hair removal or destruction. A non-pulsed red light or infrared emitting light source may be included to remove wrinkles and rejuvenate skin, or even to enhance the growth of hair.

The razor 200 may also include a power supply 212 coupled to the light sources 210 to provide an energy source for powering the light sources 210. In one embodiment, the power supply 212 may be located in the handle 202 of the razor 200. In some embodiments, the power supply 212 may comprise a battery. In one implementation, the power supply may need to be sufficient to provide approximately 0.2 W/cm² to skin over broad emitter region over a given shaving time or period. The razor 200 may further include an actuator for controlling the activation of the light source (and thereby control the emitting of the light). In one embodiment, the actuator may be provided on the handle 202 of the razor 200.

In one embodiment, the light emitting regions, or light emitting delivery means may be designed so that the skin exposure would be less than some predetermined power level, to prevent over exposure, for example below the maximum permissible exposure, MPEₛₖᵢₙ, as determined by accepted regulation. The light delivery means may be also designed such that eye exposure levels do not reach an unsafe level.

In embodiments where the battery power supply 212 comprises a rechargeable battery, a connection may be provided to connect the battery to an external power supply to (re)charge the battery. In one such embodiment, a charging base 214 may be provided that is connectable (such as, e.g., via a power cord) to an external power supply such as an electrical outlet. The razor 200 may then be coupled or inserted into the charging base 214 to charge the battery 212. As shown in the embodiment depicted in FIG. 17, the battery 212 may be located in the handle 202 of the razor and the charging base 214 may include some sort of receptacle for receiving at least a portion of the handle. In one embodiment, the charging base 214 and the razor 200 may include complementary circuitry to permit charging of the battery through induction between the razor and the charging base.

The light sources 210 may be arranged in a variety of configurations in order to shine light from or proximate to the head 206. For example, in some embodiments, the head 206 may include one or more openings, holes and/or windows (and combinations thereof) adjacent the blades 208 to permit light to pass from inside the head 206 to the exterior regions adjacent (or proximate) to the blades 208. In other embodiments, the head 206 may be shaped or configured so that the light sources 210 shine a light on to a skin surface that has just been cut with the blades of the razor (it should be noted that such embodiments may be used in conjunction with the former window/hole/opening embodiments).

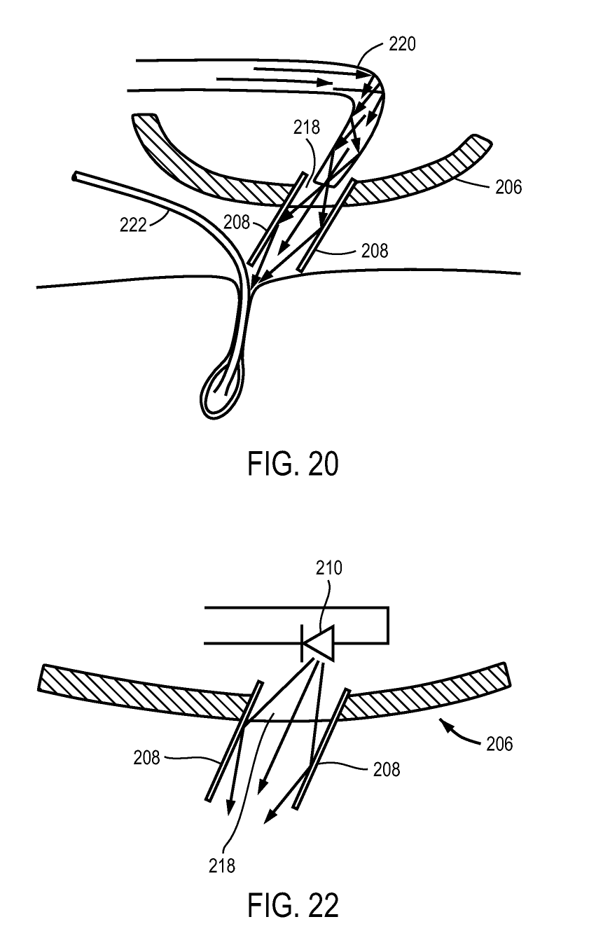

FIGS. 18, 19 and 20 show various light source implementations of the head where a light pipe is used to emit light from between and proximate the blades. FIGS. 18 and 19 depict embodiments of the head 206 that include a window 216. FIG. 20 depicts an embodiment where the head 206 includes an opening 218 between the blades 208. In these embodiments, one or more light pipes 220 provide a light conduit between the light sources 210 located inside the razor (e.g., in the handle, shaft or head) to regions adjacent the blades in the head 206. These light pipes 220 may comprise optical fibers (i.e., fiber optics), tubes having lumens through which light passes, or solid light pipes (i.e., non-hollow lumens). In general, one end(s) of the light pipe(s) 220 is posited in the razor so that it is adjacent the light source(s) and the other end(s) of the light pipe(s) is positioned adjacent the blade(s) so that light from the light source(s) can pass through the light pipe(s) to the “open” end(s) near the blade(s). In use, the light pipe(s) 220 helps guide light emitted from the light source(s) to the delivery end(s) so that light from the light source(s) 210 is emitted from the delivery end of the light pipe. In one embodiment, a single light pipe may be used having a single end adjacent the light source(s) and a multi-furcated end adjacent the blades of the razor to help shine light upon desired areas proximal to the blades.

In embodiments where the head 206 of the razor 200 includes one or more windows, the window(s) may be transparent or translucent to permit passage therethrough of some or all, respectively, of the light from the light sources. Such window(s) may also be frosted to aid diffusion of light from the light sources. For example, the inside surface of a window may be roughened or impregnated with a scattering material to provide a lambertian-like scattering transmission.

FIGS. 21 and 22 show implementations where the one or more treatment light sources 210 are located in the head 206 of the razor 200. More particularly, FIG. 21 depicts an implementation with the light source(s) 210 in the head of the razor where the head has a window 216 and FIG. 22 depicts an implementation with the light source(s) 210 in the head 206 of the razor 200 where an opening 218 is provided in the head 206 between the blades 208.

In some cases the light may not only provide beneficial effects to the skin and tissues, but also directly heat the cutting blades to further help enhance the cutting effectiveness of the razor.

The placement of the open or free end(s) of the light pipe(s) 220 may depend on where the light is to be directed for a given implementation. For example, delivering to a hair follicle or root may be particularly useful for the treatment of acne related issues while blue light illumination of a follicular region may be useful to prevent undue bacterial population. As shown in FIG. 20, in order to deliver light to a follicle/root of a hair 222 being shaved, the end of the light pipe 220 may be provided between the space between adjacent 208 blades to provide light path toward or into hair root. In this configuration, the blades 208 may pull hair up and out while light emitted from the free end of the light pipe travels down hair follicle path to root of the hair.

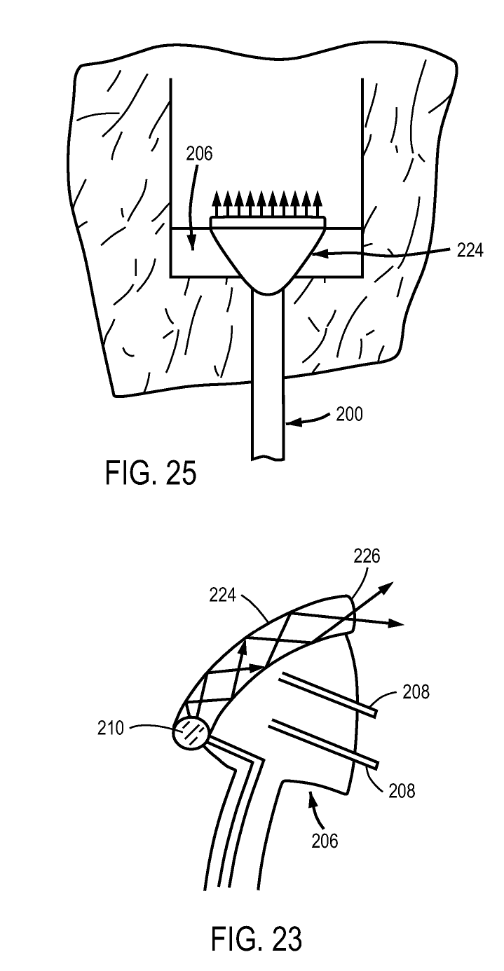

FIGS. 23, 24, 25, 26, 27, 28 and 29 show embodiments of the razor 200 (or portions thereof) having a light pipe 224 (which in this embodiment, may be referred to as a “light manifold”) extending over at least a portion of the back side of the head 206 opposite the blade side of the head 206 so that the open end of the light pipe 224 is positioned towards the top of the head so and orientated so that light is emitted therefore on the blade side of the head and/or the top of the head. In this embodiment, one or more treatment light sources 210 (e.g., one or more LEDs) may be provided in the head at the other end of the light manifold. The manifold 224 may be hollow, or solid made of a suitable transparent plastic, or filled with a similar material that is used to make fiber optic fibers. The open end of the light manifold 224 may be closed with a transparent or translucent window 226 to permit light to emit out of the light manifold but to prevent fluid and other debris from entering into the light manifold. Like the other windows described herein, the window 226 of the open end of the light manifold 224 may be frosted to aid in diffusing light from the light source(s).

In use, the light manifold 224 may be useful for addressing skin directly for anti-bacterial, rejuvenation or wrinkle treatment for example by bringing light to the shaven path above blade track to thereby illuminate freshly shaved skin. Light is spread from source to contact or in close proximity to skin, to cover path of razor 200.

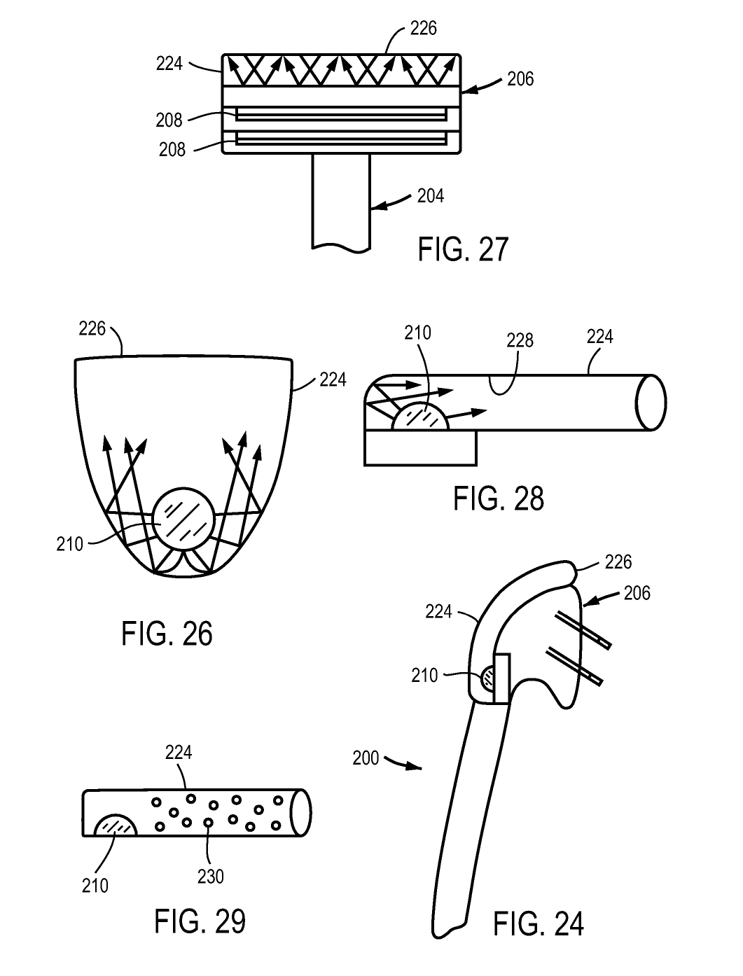

As best shown in FIGS. 23 and 24, the light manifold 224 may be curved to conform to the back side of the head 206. As shown in FIGS. 25, 26 and 27, in some embodiments, the open end of the light manifold 224 may be flared to a width up to the width of the head 206 so that light can shine across the width of the head 206.

As shown in the implementation depicted in FIG. 23, the treatment light source(s) 210 may be positioned so that it is orientated upwards towards the top of the head 206 of the razor 200. Alternatively, the light source(s) 210 may be positioned so that is positioned facing away from the back of the head as depicted in FIGS. 24 and 28. As shown in FIG. 27, the open end of the manifold 224 may be frosted or ground to help diffuse the light being emitted from the open end.

The light pipes 220 and/or the light manifold 224 described herein may also include a silvered or light reflecting coating on an inner surface or lumen 228 (as depicted in the embodiment of the light manifold shown in FIG. 28) to help reflect light from the light source towards the open end of the light pipe/light manifold. In addition (or alternatively), the inner surface/lumen 228 of a light pipe 220/light manifold 224 may include scatterers or index perturbations 230 to help diffuse or homogenize the light before it is emitted from the open end of the light pipe/light manifold (as depicted in the embodiment of the light manifold shown in FIG. 29). Output surface of 224 may be frosted to homogenize the output, or prevent unsafe eye exposure levels.

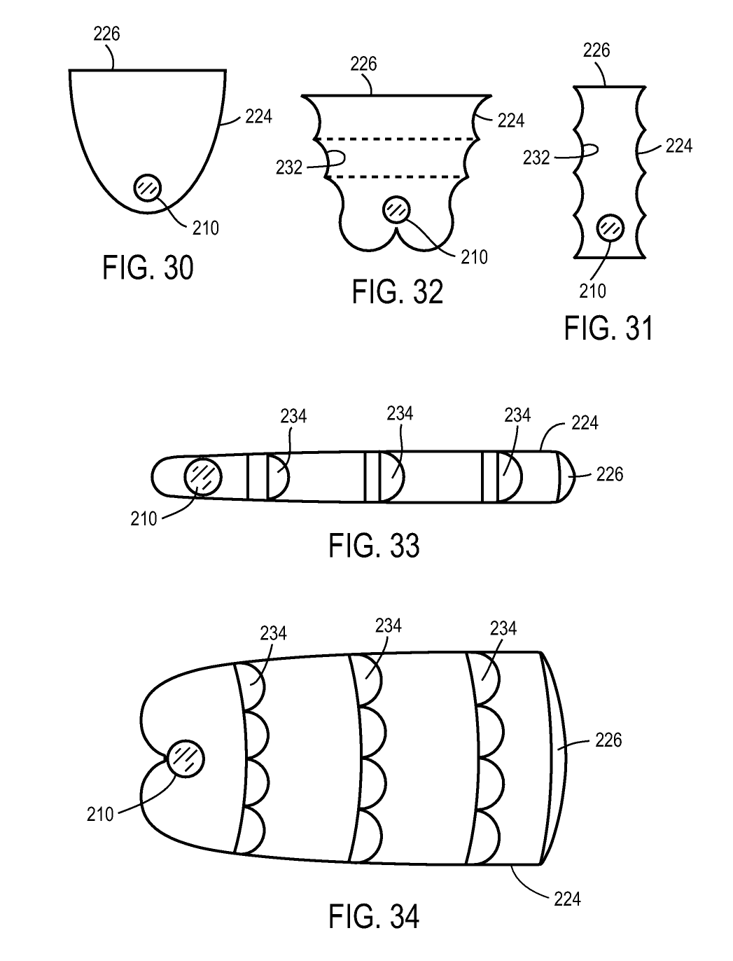

The shape of the light pipe 220/light manifold 224 may also be varied to suit a particular implementation. For example, a basic configuration of a light manifold 224 is shown in FIG. 30 where the treatment light source(s) 210 are located at the back of the manifold. In FIGS. 31 and 32, the light pipe 220/light manifold 224 may have concave or convex surfaces 232 that create protuberances to help homogenize or distribute the light from the light source into a desired distribution. As previously mentioned, these interior surfaces of the light pipe 220/light manifold 224 may also be constructed so that they are highly reflective (e.g., highly polished or a reflective coating).

FIGS. 33 and 34 show alternative versions of the lenslets 234 that are arranged in rows or lines perpendicular to the length of the light pipe 220/light manifold 224. These lenslets 234 may comprise molded intermediate features to provide deviation in beam path. Each lenslet 234 may help enhance the spreading of light. The top/bottom/sides of the light pipe 220/manifold 224 in such an implementation may be highly reflective.

In use, a skin surface may be shaved using any of the implementations of the razor 200. Prior to shaving, a shaving cream or other lubricating substance may be applied to the skin surface. When shaving, the treatment light source(s) may be activated in order to shine light on the area of the skin being shaved and/or that has been shaved.

### Electric Razor Implementations

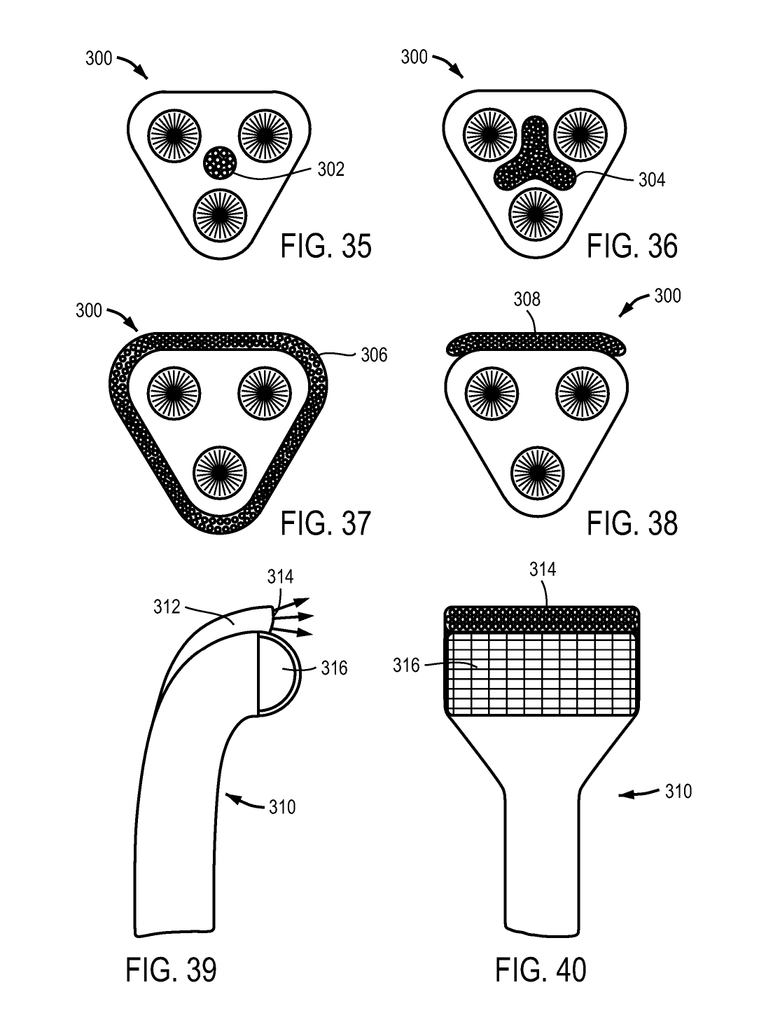

FIGS. 35, 36, 37 and 38 show various embodiments of a rotating blade head type electric razor 300 with one or more treatment light sources.

In particular, FIG. 35 shows a triple rotating blade head type electric razor 300 with a centrally located light emitting region 302 from which light may emit (e.g., from a treatment light source in the head) to an area of skin adjacent the electric razor head. FIG. 36 shows an implementation of the triple rotating blade type electric razor 300 with a generally Y-shaped light emitting region 304 that is also centrally located that may be implemented to provide additional light power to the area around electric razor head. The embodiments shown in FIGS. 35 and 36 may be implemented with one or more treatment light sources in the head of the electric razor 300 proximate to the light emitting region or with light pipes having free ends extending to the emitting region and the light source(s) located somewhere inside the electric razor. Like the other embodiments described herein, the light emitting region may comprise one or more windows that may be transparent or translucent (e.g., through tinting or frosting) to help diffuse the light emitted therethrough.

FIGS. 37 and 38 show two implementations of triple rotating blade type electric razors 300 with light manifolds for emitting light from a light source in the razor. As depicted in the implementation shown in FIG. 37, the light emitting open end 306 of the light manifold may extend completely or substantially around the outer periphery of the razor head so that light is emitted around the razor head. Alternatively, the light emitting open end 308 of the light manifold may extend only partially around the outer periphery of the razor head, such as, for example, along one or two sides of the outer periphery as depicted in the implementation shown in FIG. 38. The open ends 306, 308 of the light manifolds in the electric razor embodiments shown in FIGS. 37 and 38, may be closed with a transparent or translucent window to permit light to emit out of the light manifold but to prevent fluid and other debris from entering into the light manifold. Like the other windows described herein, the window of the open end of the light manifold may be frosted to aid in diffusing light from the light source(s).

FIGS. 39 and 40 show an embodiment of an oscillating or reciprocating blade type electric razor 310 with a light manifold 312. The open end of the light manifold may be closed with a transparent or translucent window 314 to permit light to emit out of the light manifold but to prevent fluid and other debris from entering into the light manifold. Like the other windows described herein, the window 314 of the open end of the light manifold 312 may be frosted to aid in diffusing light from the light source(s). In such an embodiment, the light manifold 312 may direct light from one or more treatment light sources in the electric razor 310 across at least a portion of the width of the cutting blade region 316 at the head of the electric razor. As shown in FIG. 40, in one such embodiment, the open end 314 (i.e., the window end) of the light manifold may extend substantially across the width of the cutting blade region 316 at the head of the electric razor 310.

In use, a skin surface may be shaved using any of the implementations of the electric razor 300 or 310. When shaving, the treatment light source(s) may be activated in order to shine light on the area of the skin being shaved and/or that has been shaved (depending on the implementation).

While various embodiments have been described above, it should be understood that they have been presented by way of example only, and not limitation. Thus, the breadth and scope of any embodiment should not be limited by any of the above described exemplary embodiments, but should be defined only in accordance with the following claims and their equivalents.

What is claimed:

1. A toothbrush, comprising:
a head having a plurality of bristles and a window; and
a light source for emitting light through of the window.

2. The toothbrush of claim 1, further comprising a handle, the light source being disposed in the handle.

3. The toothbrush of claim 2, further comprising a light tube extending between the light source and the head, the light tube having at least one distal end located proximal to the window so that light emitted from the light source passes through the light tube to the distal end of the light tube.

4. The toothbrush of claim 1, wherein the light source emits light in the blue spectrum.

5. The toothbrush of claim 1, wherein the light emitted from the light source has a wavelength between about 400 nm and 500 nm.

6. The toothbrush of claim 1, further comprising a heating element in the head.

7. The toothbrush of claim 6, wherein the heating element is coupled to a battery power supply for providing energy to the heating element.

8. The toothbrush of claim 6, wherein the heating element conducts heat radiated by the light source to an external area proximal to the head.

9. The toothbrush of claim 6, further comprising a temperature sensor for controlling the heat radiated by the heating element.

10. The toothbrush of claim 1, wherein the bristles are arranged in a ring around the window.

11. The toothbrush of claim 1, further comprising a motor for moving the bristles.

12. The toothbrush of claim 11, wherein the bristles are mounted to an assembly that is rotatably mounted to the head, the motor being coupled to the assembly to at least oscillate the assembly.

13. The toothbrush of claim 1, further comprising a housing having inner and outer portions, the outer portion comprising a material that is at least translucent.

14. The toothbrush of claim 1, further comprising a cap for covering the head and the bristles.

15. The toothbrush of claim 14, wherein the cap has a reflective interior surface.

16. The toothbrush of claim 1, further comprising a catalytic material provided on at least the head.

17. The toothbrush of claim 16, wherein the catalytic material is provided on a removable cap that is detachably attached to the head.

18. A method of brushing teeth, comprising:
providing a toothbrush having a plurality of bristles and a light source proximal to the bristles;
activating the light source to emit light from the light source;
brushing at least one tooth such that light from the light source shines on the tooth.

19. A razor, comprising:
a head having at least one blade;
a light source adapted for emitting light proximal to the head.

20. The razor of claim 19, further comprising a light pipe extending between the light source and the head, the light emitted from the light source passing through the light pipe in order to emit light proximal to the head.
